(19) United States
(12) Patent Application Publication
(10) Pub. No.: US 2008/0083816 A1
(43) Pub. Date: Apr. 10, 2008

(54) Statistical process control of solder paste stenciling using a replicated solder paste feature distributed across a printed circuit board

(76) Inventors: Glen E. Leinbach, Ft. Collins, CO (US); Stacy Kalisz Johnson, Gilbert, AZ (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/542,907

(22) Filed: Oct. 4, 2006

(51) Int. Cl. B23K 31/00

(52) U.S. Cl. 228/102; 228/8

(57) ABSTRACT

Methods and systems for improving a solder paste stenciling process include obtaining data pertaining to solder paste deposits on a printed circuit board, the solder paste deposits deposited by a solder paste stenciling process through multiple identical apertures of a solder paste stencil, statistically analyzing the data, and correlating the data with a plurality of solder paste stenciling process problems to identify at least one solder paste stenciling process problem in the solder paste stenciling process.

### BACKGROUND OF THE INVENTION

The present invention relates generally to solder paste stenciling, and more particularly to statistical process control of solder paste stenciling using a replicated solder paste feature distributed across a printed circuit board.

Solder-joint defects are a leading contributor to printed-circuit board failure at in-circuit and functional test as well as a primary cause for costly warranty returns. Solder application is a primary source of those failures. Missing or insufficient solder prevents electrical contact and excessive solder can lead to shorts. Increasingly popular components such as array packages, (BGA, CSP and Flip Chip) with their miniscule contact points, have made the need for precise solder application even more critical.

The quality and repeatability of the solder paste stenciling process in printed circuit board assembly (PCBA) manufacturing is critical to the quality and reliability of the solder joints of the PCBAs being assembled. Variations in the position, volume, printed size, print thickness, and other physical characteristics of solder paste deposits can prevent acceptable solder joints from being formed during the solder reflow process. Additionally, studies have shown that solder joint volume is related to long-term reliability of solder joints. The solder paste variations can be caused by many things. Examples include but are not limited to lack of coplanarity between the stencil and the bare printed circuit board (PCB), lack of solder paste on the stencil, incorrect snap-off distance, misalignment between the stencil and PCB, incorrect type or out-of-specification solder paste, solder paste on the bottom of the stencil, plugged stencil apertures, and suboptimal stenciling speed. A more thorough list of parameters and features, which contribute to variations of the solder paste stenciling process is attached as Appendix 1.

FIG. 1 is a diagram illustrating, by way of example only and not limitation, typical defective solder paste deposits on a portion of a PCB 100 after the solder paste stenciling process. As shown, the defective solder paste deposits 111, 112, 113, 114, 115 have some areas of the corresponding pads 101, 102, 103, 104, 105 without any coverage at all. Furthermore, some of the solder paste of solder paste deposits 104 and 105 has leaked out onto areas of the board outside their predefined pads 114, 115. Clearly, this is problematic in that when the solder is later reflowed, the solder will bubble in places and leave some areas of the metal pads without solder.

FIG. 2 is a diagram illustrating a portion of a PCB 200 having acceptable solder paste deposits 211, 212, 213, 214, 215. In this example, the solder paste deposits 211, 212, 213, 214, 215 uniformly cover the pads 201, 202, 203, 204, 205 of the PCB and do not leak onto areas of the PCB outside the predefined deposit areas.

Inspection of PCBs is typically performed after the solder reflow step in the manufacturing process in order to detect defects in solder joints. Automated optical or x-ray inspection may be used to perform the inspection. However, post-reflow inspection is not useful in the identification of solder paste deposition problems because the reflow process transforms the problem space—that is, if solder paste deposition problems exist prior to the reflow step, the reflow step operates to transform the defects—that is, reflow fixes some defects and induces others. Thus, automated inspection post-reflow is of limited use for identifying problems in the solder paste stenciling process.

In an effort to mitigate the number of faults attributed to the initial solder paste deposition step in the manufacturing process, electronics manufacturers and their equipment suppliers have paid a lot of attention to improving the effectiveness of solder-paste deposition. Many manufacturing operations have implemented storage, cleaning, and management procedures for paste and stencils. Solder paste printing equipment suppliers have provided increasingly sophisticated systems for measuring and controlling process parameters such as squeegee pressure, squeegee speed and snap-off height. Automated screen printers may use machine vision for the alignment of the stencil to the PCB, and some systems extend this machine vision capability to offer limited post-deposition-process verification of the pasted board.

For example, automated inspection systems such as automated optical inspection (AOI) or automated x-ray inspection (AXI) systems may be used to detect gross or obvious problems in the solder paste printing process such as solder leakage outside predefined solder paste deposit areas on a PCB, or insufficient paste. However, this type of inspection has been used mainly as a screening tool and not as a way to control the solder paste stenciling process. One reason for this is that, due to the tradeoff between manufacturing line throughput speed and solder paste deposit inspection image resolution, previous AOI and AXI technologies have been unable to adequately inspect solder paste deposits. In particular, unique measurement of the volume and shape of the solder paste deposits requires AOI or AXI with 3-dimensional (3-D) inspection capabilities for measuring and analyzing both the planar (X and Y) and the thickness (Z) characteristics of the solder paste deposits. However, 3-D inspection has traditionally required heavy processing time, making it too slow for effective use in solder paste deposition inspection in high-volume manufacturing. Two-dimensional (2-D) automated inspection systems require far less processing time, but have the capability to measure and analyze only the planar (X and Y) characteristics of the solder paste deposits, and therefore cannot be used to reliably identify many major solder paste deposit problems.

Limitations in the quality of the inspection also limit the effectiveness of statistical process control (SPC) of the solder paste stenciling process. In addition, SPC of manufacturing processes is most effective when unwanted variables among the features measured and used for SPC are minimized or eliminated. In the solder paste stenciling process, however, there are so many possible variables that SPC so far has also been of limited use. For example, in surface mount technology (SMT) assemblies, many variations exist in the component lead finishes, board finishes, board thickness, and how the boards heat in reflow, to name only a few variables. Furthermore, although there may be many repeated small features on any given printed circuit board, the same features are often not present on every board processed through the manufacturing line. This means that the SPC tool must be customized for each board design, requiring SPC tool setup and configuration time of process engineers to select which features to use and to characterize. In addition, because such features are not usually scattered all over the board, additional time must be invested into generating the most valid data for effective process control.

Additionally, considerable amount of variation also exists, by design, in the aperture and solder paste deposit sizes across any given PCBA design. This variation exists because for electrical and mechanical components being attached to the PCBA, the size and shape of each aperture and ensuing solder paste deposit on a PCBA design is determined by the desired characteristics of the solder joint being made between the metalized area (e.g., land or pad) on the board and the metalized connection (e.g., pin or lead) of the component.

Accordingly, as is made clear above, it is difficult to control the solder paste stenciling process sufficiently to produce PCBAs with low defect levels.

### SUMMARY OF THE INVENTION

An embodiment of a method for learning about a solder paste stenciling process for printed circuit board assembly manufacturing includes generating a solder paste stencil, the solder paste stencil comprising multiple identical apertures; masking a printed circuit board with the solder paste stencil; applying solder paste deposits in the apertures of the solder paste stencil; removing the solder paste stencil; collecting data pertaining to the solder paste deposits; and performing statistical process control on the collected data for use in learning about the solder paste deposition process.

An embodiment of method for identifying solder paste stenciling process problems in a solder paste stenciling process for printed circuit board assembly manufacturing includes obtaining data pertaining to solder paste deposits on a printed circuit board, the solder paste deposits deposited by a solder paste stenciling process through multiple identical apertures of a solder paste stencil; statistically analyzing the data; and correlating the data with a plurality of solder paste stenciling process problems to identify at least one solder paste stenciling process problem in the solder paste stenciling process.

An embodiment of a solder paste deposition system includes a solder paste printer which performs a solder paste stenciling process, the solder paste printer having a solder paste stencil mounted therein, the solder paste stencil having multiple identical apertures, the solder paste printer configured to receive a printed circuit board, mask the printed circuit board with the solder paste stencil, apply solder paste into the apertures of the solder paste stencil, and remove the solder paste stencil to leave solder paste deposits on the printed circuit board; an automated inspection apparatus which obtains measurements of the solder paste deposits; and a statistical process control system which determines whether the solder paste stenciling process performed by the solder paste printer is suffering from at least one of a plurality of solder paste stenciling process problems and indicates to a user the identified at least one of the plurality of solder paste stenciling process problems.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a top view of a set of defective solder paste deposits on a PCB;

FIG. 2 is a top view of a set of acceptable solder paste deposits on a PCB;

FIG. 3 is a block diagram of an embodiment of a solder paste deposition/reflow system;

FIG. 4 is a perspective exploded view of a solder paste deposition station;

FIG. 5 is an operational flowchart of an embodiment of a method for learning about a solder paste stenciling process for printed circuit board assembly manufacturing; and

FIG. 6 is an operational flowchart of an embodiment of a method for identifying solder paste stenciling process problems in a solder paste stenciling process for printed circuit board assembly manufacturing.

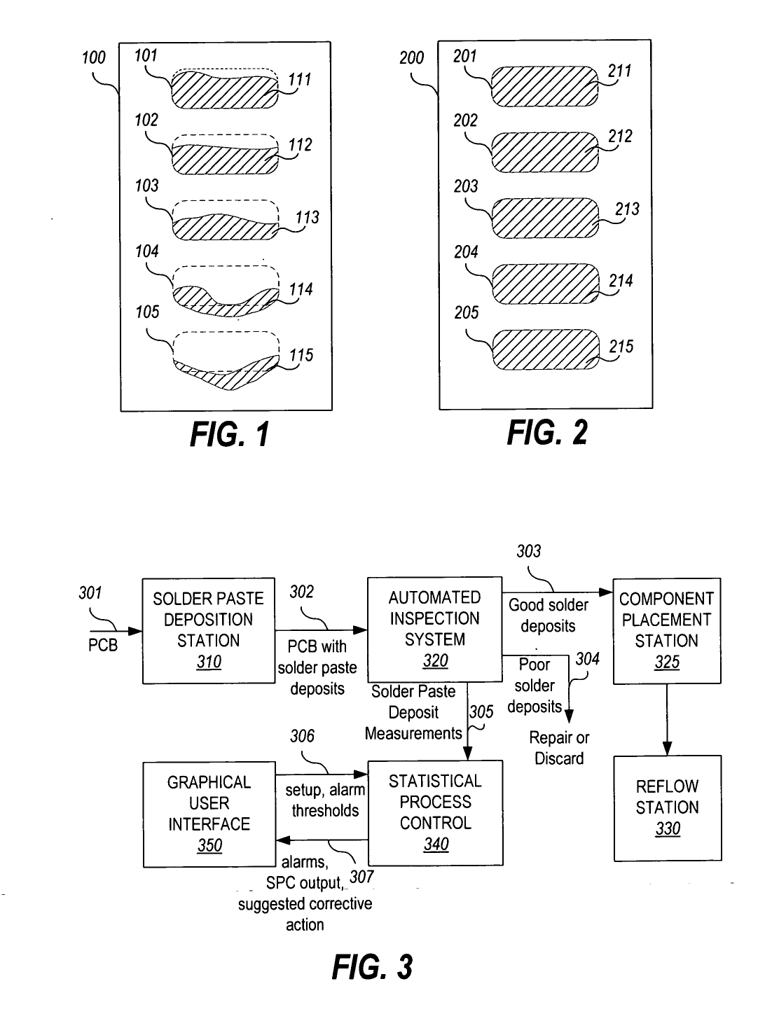

### DETAILED DESCRIPTION

FIG. 3 is a block diagram of an embodiment of a solder paste deposition/reflow system 300. In this embodiment, a solder paste deposition station 310 receives a PCB 301 which includes conductive traces and/or other conductive surface areas thereon.

The solder paste deposition system 310 deposits solder paste on areas of the PCB defined by a solder paste stencil to produce a PCB 302 having solder paste deposits thereon. The solder paste stencil includes a plurality of apertures that are the same size and shape (and may also include other apertures of differing sizes and shapes). In one embodiment, a set of apertures of the same size and shape correspond to locations on the PCB (when the stencil is aligned over the PCB) at which bead probes are to be fabricated.

An automated inspection system 320 performs automated inspection of the solder paste deposits of the PCB 302. For example, the automated inspection system 320 may comprise an automated optical inspection (AOI) system or an automated X-ray inspection (AXI) system. During inspection of the solder paste deposits, the automated inspection system 320 obtains measurements 305 of various parameters pertaining to the solder paste deposits on the PCB 302. Examples of parameters that may be measured are listed in Appendix 1.

Based on the measurements 305, the automated inspection system 320 classifies the PCB 302 as either a good PCB 303 having solder paste deposits that meet predetermined passing criteria or a bad PCB 304 having solder paste deposits that do not meet the predetermined passing criteria. Good PCBs 303 are then sent to a component placement station 325 which places components on the PCB such that component leads align with pads on the PCB, and then to a reflow station 330 where solder is reflowed (i.e., melted) onto the surface of the PCB 303 to conductively adhere solder to the conductive areas of the PCB on which solder paste is deposited. Bad PCBs 304 may be repaired-and retested prior to the reflow step.

A statistical process control function 340 collects the solder paste deposit measurements 305. In particular, the automated inspection system 320 collects measurements including physical measurement data of repeated solder paste deposits across the PCB for use by statistical process control (SPC) 340 of the solder paste stenciling process.

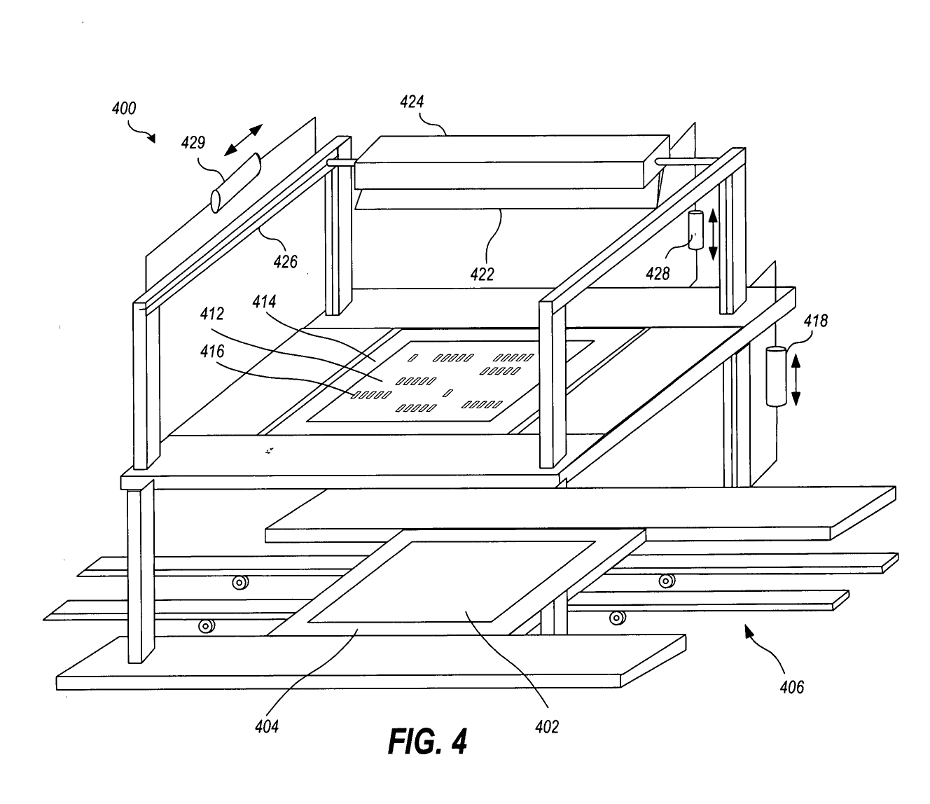

FIG. 4 shows an illustrative solder paste deposition station 400. In a solder paste deposition station, a solder paste stencil 412 is mounted in a stencil support 414. The solder paste stencil 412 is a solid sheet, such as a silkscreen, having apertures 416 in predefined locations that, when the stencil 412 is placed over a PCB 402, align with bare metal areas (e.g., pads, land) on the PCB to which solder is to be conductively connected. A PCB 402 is conveyed (for example by way of conveyor system 406) into the printer 400, clamped to and aligned within a PCB support 404, either manually or automatically (for example by robotic means and optical alignment). The solder paste stencil 412 is then aligned over the PCB 402 and lowered onto the PCB 402 (for example, by way of an actuator 416). When the solder paste stencil 412 is aligned over a PCB, bare metal areas of the PCB aligned with the stencil apertures remain exposed, while the remaining areas of the PCB are covered by the stencil and are therefore unexposed. Solder paste, dispensed by a solder paste dispenser 424, is then deposited on top of the stencil 412, and a squeegee 412 is placed into contact with the top surface of the stencil 412 (for example under control of an actuator 428). The printer then slides the squeegee 412 over the top of the stencil (for example, under the control of an actuator 429), forcing solder paste through the apertures 416 in the stencil 412 and onto the exposed areas of the PCB 402. The stencil 412 is then removed from the PCB 402, leaving behind the solder paste deposits on the surface of the PCB. The PCB 402 is then conveyed to an inspection system such as an AOI or AXI system. An exemplary embodiment of a solder paste deposition station is the Accela™ Stencil Printer manufactured by Speedline Technologies, Inc. headquartered in Franklin, Mass.

In a production line, the above-described solder paste stenciling process is repeated over and over again for each PCB to be manufactured. During the production run, various problems may prevent the deposition of acceptable solder paste deposits on the PCB. For example, the stencil can get dirty with solder paste on its bottom surface (i.e., the surface contacting the PCB), which may result in solder paste residue in unwanted places on the PCBs. In another example, the solder paste may get depleted in the first apertures encountered by the squeegee, leaving apertures later encountered by the squeegee without any or sufficient solder paste. Likewise, solder paste can dry out prior to the squeegee step. In another example, the solder paste stencil may become misaligned over time. A multitude of other solder paste stenciling process problems may also occur, many of which are difficult to measure, and many of whose symptoms are difficult to correlate with a specific root cause of a problem.

Embodiments of the invention utilize PCBs that require repeated identical solder paste deposits across the PCB. As stated previously SPC techniques have been of limited use in the solder paste stenciling process because the shapes and sizes of solder paste deposits is unpredictable from board to board. In an illustrative embodiment, candidates for use in applying SPC techniques to the solder paste stenciling process may be locations on the PCB whose size and shape are repeated many times over across the board. For example, a recent development in the fabrication of PCBs is the use of “bead probes”. Bead probes may be solder bumps (or “beads”) attached along PCB traces that may be probed by in-circuit test (ICT) system probes to allow testing of the PCBA to verify that it was assembled correctly and that the components on the PCBA are correct and conductively connected. A more detailed description of the fabrication of bead probes is found in U.S. Patent Application Publication No. 20050061540, which is incorporated by reference herein for all that it teaches.

For the fabrication of bead probes on a PCBA, the bare printed circuit board (PCB) is designed and manufactured, and locations of bead probes on traces or other metalized areas of the outer surface of the PCB are determined. During PCB design, apertures of a repeated specific size and shape are defined in the CAD artwork that are used to fabricate the solder paste stencil. The solder paste stencil is aligned over the manufactured PCB directly over the bare metal exposed by the openings in the solder mask. During the normal surface mount assembly process step of solder paste stenciling, solder paste is deposited through the apertures to lie directly on the bare metal. After normal placement of surface mount components on the PCB, the solder on the PCB is reflowed, making solder joints that physically and electrically attach the components to the PCBA. Concurrently, the solder paste deposits over the bead probe sites also melt during reflow and the surface tension of the molten solder pulls the solder into a bead that covers the bare metal. As the PCBA cools, each bead of solder retains that shape, and is called a “bead probe”.

With the advent of bead probes, many PCBAs now have multiple solder paste deposits of repeated size and shape in predictable locations across the entire PCBA after the solder paste stenciling process. Furthermore, in a given manufacturing line which may use bead probes in the post-fabrication testing process (e.g., in in-circuit testing) due to the tester itself being equipped with specialized probes for probing bead probes, all PCBAs entering into the manufacturing line may in fact be required to be fabricated with bead probes. Because of the repeatable nature of these solder paste deposits, subtle differences in their physical characteristics such as, but not limited to, size, thickness, volume, and position that are caused by variations in the stenciling process can be measured with an automated inspection system, independent of the actual PCBA design. This data can then be used very effectively for statistical process control of the solder paste stenciling process not only from board to board of the same PCBA design, but also from PCBA design to PCBA design. This makes SPC practical for the first time.

In one embodiment, physical bead probe measurement data is collected and organized into a useful form for use by an SPC system. The SPC system performs statistical calculations on the data. In one embodiment, the SPC system correlates results of the SPC analysis of the solder paste deposits to root causes of problems with the solder paste stenciling process, such as but not limited to the parameters and features listed in Appendix 1. For example, the automated inspection system may collect physical data pertaining to solder paste deposits for fabrication of bead probes including length, width, height, volume, position, etc., that may be assimilated by the SPC system.

When a solder paste deposit on a PCB is determined to be bad, a technician may investigate the physical solder paste deposition system to determine the root cause(s) of the rejected solder paste deposit. This information may then be fed into the SPC system to allow it to correlate similar measurement data associated with other bead probe solder paste deposits with the root cause. Thus, root causes of solder paste deposition problems, which are not easily identified or controlled with prior art methods, may be identified, controlled, and/or eliminated to improve the solder paste stenciling process, which leads to reduction of the number of solder paste deposit defects, and therefore reduction in failure rate of manufactured PCBAs. For example, the addition of measurements of paste area, height, placement and volume can be used to more directly link visible defects with specific actions. For instance, typical AOI measurements such as paste to pad offset may be correlated by the SPC system to a stencil alignment problem whose corrective action would be screen printer adjustment. Likewise, low area measurement may be correlated by the SPC system with dried solder paste on the stencil apertures. Corrective action such as stencil cleaning and/or stencil paste replacement may be linked to this correlation.

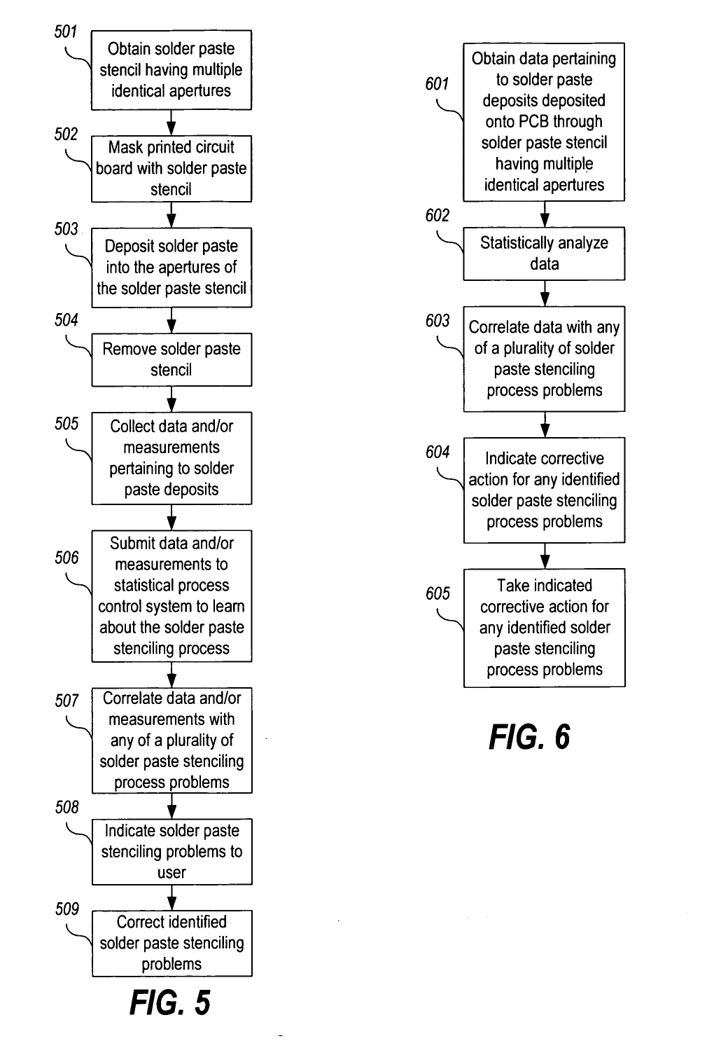

FIG. 5 is an operational flowchart of an embodiment of a method for learning about a solder paste stenciling process for printed circuit board assembly manufacturing. In this embodiment, a solder paste stencil comprising multiple identical apertures is obtained (step 501). A printed circuit board is masked with the solder paste stencil (step 502). Solder paste is deposited into the multiple identical apertures of the solder paste stencil (step 503) and the stencil is then removed from the printed circuit board (step 504). Data representing measurements or other process parameters associated with the solder paste deposits are collected (step 505) and fed to a statistical process control system for use in learning about the solder paste deposition process (step 506).

The statistical process control system may correlate the collected data with at least one of a plurality solder paste stenciling process problems to identify at least one of the plurality of solder paste stenciling process problems occurring in the solder paste stenciling process (step 507). The identified solder paste stenciling process problem(s) may be indicated to a user (step 508). The user may correct the identified solder paste stenciling process problem(s) (step 509). Representative data collected may include, for example only and not limitation, solder paste deposit volume, uniformity, length, width, thickness, offset of solder paste deposit with respect to bare metal on the printed circuit board, presence of solder paste on non-predefined solder paste deposit areas of the printed circuit board.

FIG. 6 is an operational flowchart of an embodiment of a method for identifying solder paste stenciling process problems in a solder paste stenciling process for printed circuit board assembly manufacturing. In this embodiment, data pertaining to solder paste deposits deposited on a printed circuit board by a solder paste stenciling process through multiple identical apertures of a solder paste stencil is obtained (step 601). The data is statistically analyzed (step 602), and then correlated with a plurality of solder paste stenciling process problems (step 603) to identify at least one solder paste stenciling process problem in the solder paste stenciling process (step 604). A corrective action to be taken to correct the identified solder paste stenciling process problem(s) in the solder paste stenciling process may be indicated (step 605).

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

### APPENDIX 1

1. Stencil
   1.1 Aperture shape
   1.2 Cleaning frequency
   1.3 Thickness
   1.4 Aperture size
   1.5 Kind-etching vs. electro-form vs. laser cut
2. Squeegee
   2.1 Material hardness
   2.2 Material—rubber vs. metal
   2.3 Condition
   2.4 Type—flat vs. sward vs. square
3. Solder Paste Material
   3.1 Type
   3.2 Particle size
   3.3 Particle shape
   3.4 Particle distribution
   3.5 Mechanical properties—rheology, viscosity, thixotropy
   3.6 Flux—vehicle, activator, solvent
   3.7 Alloy composition
4. Print Parameters
   4.1 Snap-off distance—on contact vs. off contact
   4.2 Stencil separation speed
   4.3 Printing speed
   4.4 Pass—single vs. double
   4.5 Squeegee levelness
   4.6 Squeegee pressure
5. Environment
   5.1 Temperature
   5.2 Air Circulation
   5.3 Humidity
   5.4 Dust and Dirt
6. Screen Printer
   6.1 Stencil to board alignment accuracy
   6.2 Vintage Model
   6.3 Printing repeatability
   6.4 Printing head
   6.5 Vision
   6.6 Printing support table
7. Printed Circuit Board (PCB)
   7.1 PCB flatness
   7.2 Solder land (pad) flatness
   7.3 Solder Land finish
   7.4 Solder Mask thickness
8. People
   8.1 Training
   8.2 Knowledge
   8.3 Authority
   8.4 Awareness

What is claimed is:

1. A method for learning about a solder paste stenciling process for printed circuit board assembly manufacturing, comprising:
generating a solder paste stencil, the solder paste stencil comprising multiple identical apertures;
masking a printed circuit board with the solder paste stencil;
applying solder paste deposits in the apertures of the solder paste stencil;
removing the solder paste stencil;
collecting data pertaining to the solder paste deposits; and
performing statistical process control on the collected data for use in learning about and controlling the solder paste deposition process.

2. The method of claim 1, wherein the multiple identical apertures correspond to bead probe locations on a PCB under assembly.

3. The method of claim 1, wherein the multiple identical apertures are of a size and shape independent of PCBA design of PCBs to be assembled in the printed circuit board assembly manufacturing.

4. The method of claim 1, comprising:
correlating the collected data with at least one of a plurality solder paste stenciling process problems to identify at least one of the plurality of solder paste stenciling process problems occurring in the solder paste stenciling process.

5. The method of claim 4, comprising:
indicating to a user the identified at least one of the plurality solder paste stenciling process problems.

6. The method of claim 4, comprising:
correcting the identified at least one of the plurality solder paste stenciling process problems in the solder paste stenciling process.

7. The method of claim 1, wherein the collected data comprise one or more solder paste deposit measurements including at least one of volume of solder paste deposit, uniformity of solder paste deposit, length of solder paste deposit, width of solder paste deposit, thickness of solder paste deposit, offset of solder paste deposit with respect to bare metal on the printed circuit board, presence of solder paste on non-predefined solder paste deposit areas of the printed circuit board.

8. A method comprising:
obtaining data pertaining to solder paste deposits on a printed circuit board, the solder paste deposits deposited by a solder paste stenciling process through multiple identical apertures of a solder paste stencil;
statistically analyzing the data; and
correlating the data with a plurality of solder paste stenciling process problems to identify at least one solder paste stenciling process problem in the solder paste stenciling process.

9. The method of claim 8, wherein the data pertaining to solder paste deposits is associated with solder paste deposits corresponding to locations of bead probes, the bead probes characterized by identical size and shape across the printed circuit board.

10. The method of claim 9, wherein the bead probes are characterized by identical size and shape across multiple printed circuit board designs.

11. The method of claim 8, comprising:
indicating a corrective action to be taken to correct the identified at least one solder paste stenciling process problem in the solder paste stenciling process.

12. A solder paste deposition system, comprising:
a solder paste printer which performs a solder paste stenciling process, the solder paste printer having a solder paste stencil mounted therein, the solder paste stencil having multiple identical apertures, the solder paste printer configured to receive a printed circuit board, mask the printed circuit board with the solder paste stencil, apply solder paste into the apertures of the solder paste stencil, and remove the solder paste stencil to leave solder paste deposits on the printed circuit board;
an automated inspection apparatus which obtains measurements of the solder paste deposits;
a statistical process control system which determines whether the solder paste stenciling process performed by the solder paste printer is suffering from at least one of a plurality of solder paste stenciling process problems and indicates to a user the identified at least one of the plurality of solder paste stenciling process problems.

13. The system of claim 12, wherein:
the measurements of solder paste deposits are associated with solder paste deposits corresponding to locations of bead probes, the bead probes characterized by identical size and shape across the printed circuit board.

14. The system of claim 13, wherein the bead probes are characterized by identical size and shape across multiple printed circuit board designs.

15. The system of claim 12, wherein:
the obtained measurements at least one of volume of solder paste deposit, uniformity of solder paste deposit, length of solder paste deposit, width of solder paste deposit, thickness of solder paste deposit, offset of solder paste deposit with respect to bare metal on the printed circuit board, presence of solder paste on non-predefined solder paste deposit areas of the printed circuit board.

16. The system of claim 12, wherein:
the automated inspection apparatus comprises an automated optical inspection system.

17. The system of claim 12, wherein:
the automated inspection apparatus comprises an automated x-ray inspection system.
